(19) United States
(12) Patent Application Publication
(10) Pub. No.: US 2017/0228708 A1
(43) Pub. Date: Aug. 10, 2017

(54) Apparatus and Methods for Generating Account Creation Information

(71) Applicant: MASTERCARD INTERNATIONAL INCORPORATED, Purchase, NY (US)

(72) Inventors: Geetika Sharma, New Delhi (IN); Amit Gupta, New Delhi (IN); Shikha Goel Mittal, Faridabad (IN)

(21) Appl. No.: 15/425,135

(22) Filed: Feb. 6, 2017

(30) Foreign Application Priority Data
Feb. 4, 2016 (SG) 10201600879V

(51) Int. Cl. G06Q 20/10; G06Q 20/34

(52) U.S. Cl. CPC G06Q 20/10; G06Q 20/357; G06Q 20/349; G06Q 50/265

(57) ABSTRACT

In an embodiment, an apparatus for generating account creation information is provided. The apparatus comprises: a computer processor and a data storage device, the data storage device having a look-up module; a value determination module; and an account creation information generation module comprising non-transitory instructions operative by the processor to: receive an indication of a travel document of a passenger; look up passenger details of the passenger, in a passenger information database coupled to the apparatus, using the indication of the travel document of the passenger; receive an indication of a currency deposit by the passenger; determine a value from the indication of the currency deposit; and generate account creation information, the account creation information comprising an indication of the passenger details of the passenger and an indication of the value.

### TECHNICAL FIELD AND BACKGROUND

The present disclosure relates to an apparatus and method for generating account creation information. The account creation information may enable a prepaid card account to be opened by an issuing bank.

The number of people travelling internationally has seen rapid growth over recent years. In 2012 there were approximately 2.8 billion international journeys were made on airlines. It is often the case that international travelers are left with an amount of foreign currency at the end of their stay in a foreign country. While large amounts of foreign currency can be readily exchanged at currency exchange counters, small amounts of currency such as coins and low denomination notes are often difficult for travelers to exchange. Thus, travelers are often left with a small amount of foreign currency at the end of their stay.

Travelers often have time between checking in with an airline and boarding their flight. This free time coupled with traveler having spare foreign currency often results in the currency being spent as cash at various merchants within an airport.

### SUMMARY

In general terms, the present disclosure proposes an apparatus and method for generating account creation information. The account creation information may be used to create a pre-paid card account for a passenger using remaining currency in their possession. The account creation information is created using so called ‘know your customer’ (KYC) information stored by an airline. This means that the passenger does not have to supply addition information to create the pre-paid card account since this information has already been provided, for example, during the purchase of a ticket or during check-in.

According to a first aspect, there is provided an apparatus for generating account creation information. The apparatus comprises: a computer processor and a data storage device, the data storage device having a look-up module; a value determination module; and an account creation information generation module comprising non-transitory instructions operative by the processor to: receive an indication of a travel document of a passenger; look up passenger details of the passenger, in a passenger information database coupled to the apparatus, using the indication of the travel document of the passenger; receive an indication of a currency deposit by the passenger; determine a value from the indication of the currency deposit; and generate account creation information, the account creation information comprising an indication of the passenger details of the passenger and an indication of the value.

The account creation information may be used by an issuing bank server to create an account such as a pre-paid card account in the name of the passenger.

In an embodiment, the data storage device further comprises an account selection module comprising non-transitory instructions operative by the processor to select between a payment card account and a loyalty account to which to add the value.

In an embodiment, the account selection module further comprises non-transitory instructions operative by the processor to compare a currency amount of the indication of the currency deposit with a first threshold and to select the loyalty account if the currency amount is less than the first threshold.

In an embodiment, the account selection module further comprises comprising non-transitory instructions operative by the processor to compare a currency amount of the indication of the currency deposit with a second threshold and to select the payment card account if the currency amount is greater than the second threshold.

In an embodiment, the account creation information is information for creating a payment card account.

In an embodiment, the indication of the currency deposit comprises an indication of a currency type and an indication of a currency amount.

In an embodiment, the passenger details comprise an indication that an identity document of the passenger has been verified.

According to a second aspect, there is provided a computer implemented method of generating account information. The method comprises: receiving, at a server, an indication of a travel document of a passenger; looking up passenger details of the passenger, in a passenger information database coupled to the server, using the indication of the travel document of the passenger; receiving, at the server, an indication of a currency deposit by the passenger; determining, in a value determination module of the server, a value from the indication of the currency deposit; and generating, in an account creation information generation module of the server, account creation information, the account creation information comprising an indication of the passenger details of the passenger and an indication of the value.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram of a network comprising an account creation information generation server according to an embodiment of the present invention;

FIG. 2 is a block diagram illustrating a technical architecture of the apparatus according to an embodiment of the present invention;

FIG. 3 is a flow diagram showing a method of generating account information according to an embodiment of the present invention; and

FIG. 4 is a flow diagram showing part of the method illustrated in FIG. 3.

### DETAILED DESCRIPTION

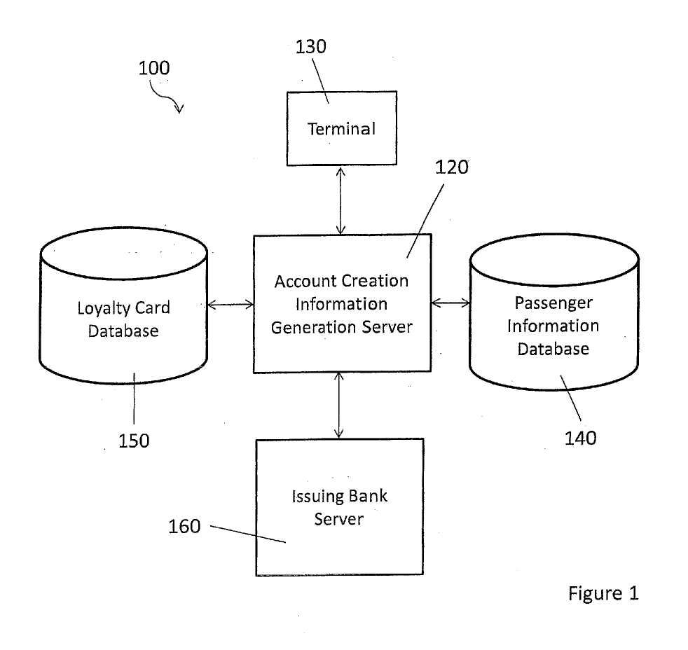

FIG. 1 is a block diagram which illustrates a network 100 comprising an account creation information generation server 120. As shown in FIG. 1, a terminal 130, a passenger information database 140, a loyalty card database 150 and an issuing bank server 160 are coupled to the account creation information generation server 120 in the network 100. The terminal 130 enables information to be input into the account creation information generation server 120 and integrated with the account creation information generation server 120 or located separately from the account creation information generation server 120. It is envisaged that the terminal 130 may be located at an airline service desk in an airport. The airline service desk may be located in an ‘airside’ area of the airport, which is an area where passengers have already been subjected to security checks following check-in. The terminal 130 may be equipped with a magnetic or optical reader which allows boarding passes or air tickets to be read. The terminal 130 is also equipped with an input device such as a keyboard which allows information on a currency deposit made by a passenger to be input. Additionally or alternatively, the terminal may comprise an automated currency collector which allows passengers to insert coins and bank notes and which is configured to determine a currency type and amount from the coins and bank notes which are inserted.

The passenger information database 140 and loyalty card database 150 may be implemented as a server coupled to one or more databases storing data. These servers may be configured to handle requests and/or communications the Account Information Generation Server 120. The various communication may take place via any type of network, for example, virtual private network (VPN), the Internet, a local area and/or wide area network (LAN and/or WAN), and so on.

The passenger information database 140 is coupled to an airline booking system of an airline. The passenger information database 140 stores information on passengers such as their full names, addresses, contact details, nationality, and details of any identification documents such as passports registered with a passenger. The passenger information database 140 also stores details of tickets and boarding passes corresponding to the passengers.

The loyalty card database 150 stores details of loyalty card which correspond to loyalty accounts registered to passengers. An example of a loyalty card account is an air miles account. The loyalty accounts each have a card number or account number associated with the account and a loyalty points or air miles balance is associated with each account. The loyalty card database 150 may also store details of the account holders of the loyalty card accounts.

The issuing bank server 160 is part of a payment network. The issuing bank server 160 may be configured to handle requests and/or communications from terminals associated with parties involved in a transaction carried out over the payment network. The payment network can be any electronic payment network which connects, directly and/or indirectly payers (consumers and/or their banks or similar financial institutions) with payees (the merchants and/or their banks or similar financial institutions). Non-limiting examples of the payment network are a payment card type of network such as the payment processing network operated by MasterCard, Inc. The various communication may take place via any types of network, for example, virtual private network (VPN), the Internet, a local area and/or wide area network (LAN and/or WAN), and so on.

The issuing bank server 160 allows payment card accounts to be opened in accordance with account creation information provided by the account creation information generation server 120.

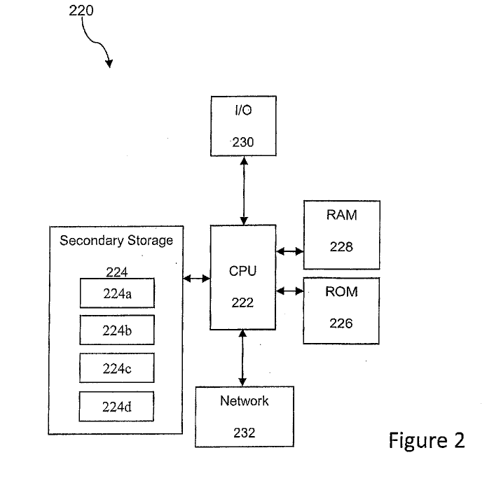

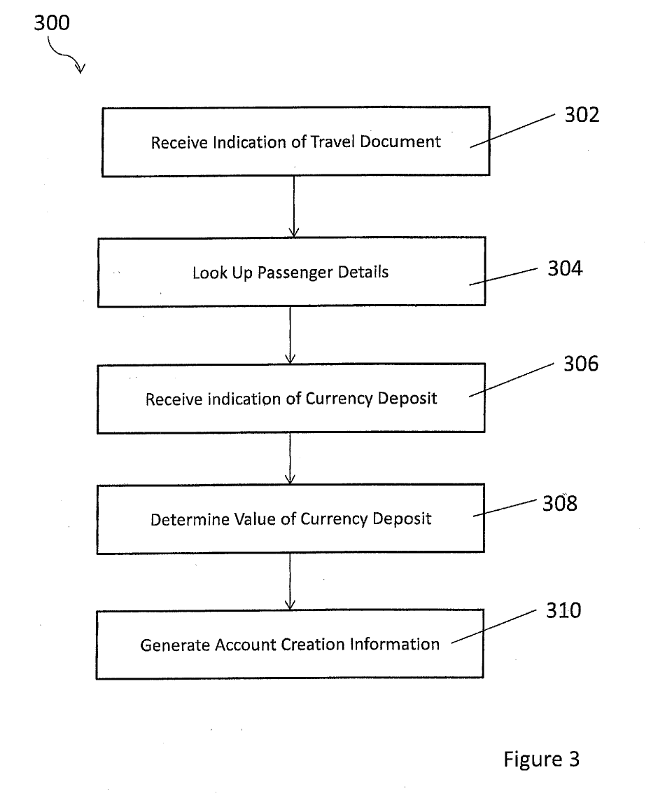

FIG. 2 is a block diagram showing a technical architecture 220 of the account creation information generation server 120 for performing an exemplary method 300 which is described below with reference to FIG. 3. Typically, the method 300 is implemented by a computer having a data-processing unit. The block diagram as shown FIG. 2 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a look up module 224a, a value determination module 224b, an account selection module 224c and an account creation information generation module 224d comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 300 will now be described with reference to FIG. 3 in respect of generation of account creation information. It should be noted that enumeration of operations is for purposes of clarity and that the operations need not be performed in the order implied by the enumeration.

In step 302, the account creation information generation server 120 receives an indication of a travel document such as an air ticket or boarding pass from the terminal 130. Step 302 may be initiated by a passenger approaching an airline service desk with foreign currency that they wish to exchange. The passenger would then present their travel document. The travel document would then be scanned at the airline service desk and the indication of the travel document is sent to the account creation information generation server 120.

In step 304, the look up module 224a of the account creation information generation server 120 looks up passenger details for the passenger in the passenger information database 140 using the indication of the travel document received from the terminal 130. The passenger details obtained from the passenger information database may include, for example, the full name and address of the passenger. The passenger details may also include an indication that the identity of the passenger has been checked, for example by the passenger providing an identity document such as a passport.

It is noted here that if the airline service desk including terminal 130 is located ‘airside’ at an airport, then passengers approaching the desk will have already checked in for their flights. The check-in process or the ticket purchase process generally involves the passenger having to provide details such as their full name and address; and there is also generally a requirement to present an identity document such as a passport. Thus it is likely that the passenger details will have already been provided by passengers approaching the airline service desk.

In step 306, the account creation information generation server 120 receives an indication of a currency deposit from the terminal 130. As described above, the passenger that approaches the airline service desk deposits an amount of currency. The indication of the currency deposit may comprise an indication of a currency such as US Dollars, Euros, or Japanese Yen, and an indication of an amount of that currency. In some embodiments, the indication of currency deposit may comprise more than one currencies as well as the respective amounts in such currencies.

In step 308, the value determination module 224b of the account creation information generation server 120 determines a value of the currency deposit by the passenger. The value may be determined in the currency in which the deposit was made in which case the value would be the amount of currency. Alternatively, the value may be determined in a different currency using an exchange rate. For example, the value may be calculated by converting the foreign currency amount into a US Dollar amount.

In step 310, the account creation information generation module 224d of the account creation information generation server 120 generates account creation information. The account creation information is sent to the issuing bank server 160. The account creation information comprises an indication of the value of the currency deposit by the passenger and details of the passenger such as their full name and address. The account creation information may further comprise an indication that an identity document such as a passport has been verified. It is noted that some jurisdictions have anti-money-laundering regulations which require that a person's identity is verified before an account such as a pre-paid credit card account is opened.

Following step 310, the issuing bank server 160 creates a pre-paid card account in the name of the passenger with a balance determined from the value calculated in step 308. A pre-paid card corresponding to the account is issued to the passenger at the airline service desk.

The passenger can then use the pre-paid card when making purchases at the airport.

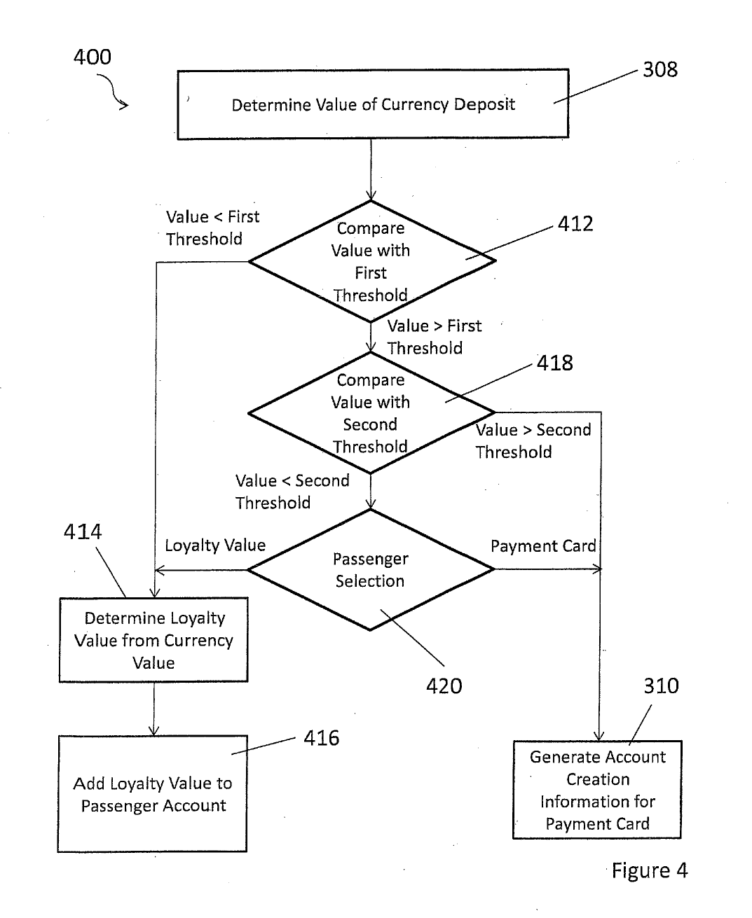

In some embodiment, the currency deposit by the passenger may be converted to loyalty points or air miles. The decision on whether to convert the currency deposit into a balance on a pre-paid card or into a loyalty card or air miles account may be made in dependence on the value calculated in step 308. Such an embodiment is described in more detail below with reference to FIG. 4.

FIG. 4 is a flowchart showing additional steps which may take place between steps 308 and 310 in an exemplary method 400.

As described above with reference to FIG. 3, in step 308 the value determination module 224b of the account creation information generation server 120 determines a value of the currency deposit by the passenger. In the method 400, following the calculation of the value of the currency deposit by the passenger, the value is compared with two thresholds and the results of the comparisons are used to determine whether loyalty value such as points or air miles are added to the passenger's loyalty account or a pre-paid card account is opened for the passenger.

In step 412, the value is compared with a first threshold. If the value is less than the first threshold the method moves to step 414. In step 414, a loyalty value is determined from the currency value, and the method moves to step 416 in which the loyalty value is added to the passenger account. This may take place by a message being sent to the loyalty card database 150 from the account creation information generation server 120. The passenger's loyalty account number may be determined either from the passenger information stored in the passenger information database 140, or by the passenger providing a loyalty card such as an air miles card at the terminal 130.

If in step 412, the value is determined to be greater than the first threshold, the method moves to step 418. In step 418, the value is compared with a second threshold. The second threshold is greater than the first threshold. If the value is greater than the second threshold, the method moves to step 310 in which account creation information is generated for a pre-paid card account as described above with reference to FIG. 3.

If in step 418, the value is determined to be less than the second threshold, the method moves to step 420. In step 420, the passenger is given the choice between adding a loyalty value such as air miles and opening a pre-paid card account with the value determined from the currency deposit. If the passenger selects adding loyalty value to their account in step 420, the method moves to step 414. If the passenger selects the payment card option in step 420, the method moves to step 310.

In some embodiments, step 420 may comprise the passenger being prompted to indicate a split of the value, so that part of the value is credited to the loyalty card and the remaining value is credited to the prepaid card. In such embodiments, steps 414 and 416 would be followed to add the selected loyalty value to the passenger account and step 310 would be followed to credit the remaining amount to the prepaid card.

In some embodiments, step 418 may be omitted, and if in step 412, the value is determined to be greater than the first threshold, the method moves to step 420.

As described above, embodiments allow foreign currency to be exchanged by a passenger for either a pre-paid payment card or loyalty points such as air miles. In embodiments, several different currencies may be loaded onto the pre-paid card.

Whilst the foregoing description has described exemplary embodiments, it will be understood by those skilled in the art that many variations of the embodiment can be made within the scope and spirit of the present invention.

1. An apparatus for generating account creation information comprising:
a computer processor and a data storage device, the data storage device having a look-up module; a value determination module; and an account creation information generation module comprising non-transitory instructions operative by the processor to:
receive an indication of a travel document of a passenger;
look up passenger details of the passenger using the look-up module, in a passenger information database coupled to the apparatus, using the indication of the travel document of the passenger;
receive an indication of a currency deposit by the passenger;
determine a value from the indication of the currency deposit using the value determination module; and
generate account creation information using the account creation information generation module, the account creation information comprising an indication of the passenger details of the passenger and an indication of the value.

2. An apparatus according to claim 1, the data storage device further comprising an account selection module comprising non-transitory instructions operative by the processor to select between a payment card account and a loyalty account to which to add the value.

3. An apparatus according to claim 2, wherein the account selection module further comprises non-transitory instructions operative by the processor to compare a currency amount of the indication of the currency deposit with a first threshold and to select the loyalty account if the currency amount is less than the first threshold.

4. An apparatus according to claim 3, wherein the account selection module further comprises comprising non-transitory instructions operative by the processor to compare a currency amount of the indication of the currency deposit with a second threshold and to select the payment card account if the currency amount is greater than the second threshold.

5. An apparatus according to claim 1, wherein the account creation information is information for creating a payment card account.

6. An apparatus according to claim 1, wherein the indication of the currency deposit comprises an indication of a currency type and an indication of a currency amount.

7. An apparatus according to claim 1, wherein the passenger details comprise an indication that an identity document of the passenger has been verified.

8. A computer implemented method of generating account information, the method comprising:
receiving, at a server, an indication of a travel document of a passenger;
looking up passenger details of the passenger, in a passenger information database coupled to the server, using the indication of the travel document of the passenger;
receiving, at the server, an indication of a currency deposit by the passenger;
determining, in a value determination module of the server, a value from the indication of the currency deposit; and
generating, in an account creation information generation module of the server, account creation information, the account creation information comprising an indication of the passenger details of the passenger and an indication of the value.

9. A method according to claim 8, wherein the indication of the currency deposit comprises an indication of a currency type and an indication of a currency amount.

10. A method according to claim 8, wherein the account creation information is information for creating a payment card account.

11. A method according to claim 8, wherein the passenger details comprise an indication that an identity document of the passenger has been verified.

12. A non-transitory computer readable medium having stored thereon program instructions for causing at least one processor to perform a method according to claim 8.

13. A system for generating account creation information for a travelling passenger, the system comprising:
a terminal having at least one input device for accepting one or more details of a travel document associated with a passenger, and an automated currency collector which allows the passenger to deposit currency with the terminal; and,
a computer processor coupled with the terminal, the computer processor having associated therewith stored non-transitory instructions operative, when executed, to cause the computer processor to:
initiate look up of details associated with the passenger based on the one or more details of the travel document;
determine a value of the currency deposited with the terminal; and,
initiate generation of account creation information including the looked-up details associated with the passenger and the value of the currency deposited with the terminal.

14. A system according to claim 13, wherein said at least one input device includes a magnetic reader.

15. A system according to claim 13, wherein said at least one input device includes an optical reader.

16. A system according to claim 13, wherein said terminal including at least one input device for accepting one or more details related to the currency deposited with the terminal.

17. A system according to claim 13, wherein the details associated with the passenger are maintained on a passenger information database which is coupled to a system maintained by an issuer of the travel document.

18. A system according to claim 13, wherein the generated account creation information is automatically transmitted to a sever of an issuing bank.
